(19) United States
(12) Patent Application Publication
(10) Pub. No.: US 2016/0062217 A1
(43) Pub. Date: Mar. 3, 2016

(54) Apparatus, Systems and Methods for Supporting a Tablet Device used with a Camera

(71) Applicant: David SLATER, Vancouver (CA)

(72) Inventor: David Slater, Vancouver (CA)

(21) Appl. No.: 14/781,557

(22) PCT Filed: Apr. 1, 2014
(86) PCT No.: PCT/IB2014/060348

§ 371 Date: Sep. 30, 2015

Related U.S. Application Data
(60) Provisional application No. 61/807,917, filed on Apr. 3, 2013.
(60) Provisional application No. 61/847,248, filed on Jul. 17, 2013.

(51) Int. Cl. G03B 17/56; H04N 5/225; G06F 1/16; F16C 11/10; F16M 13/02

(52) U.S. Cl. CPC G03B 17/566; F16C 11/10; F16M 13/02; G06F 1/1626; H04N 5/2251

(57) ABSTRACT

A camera-tablet device mounting apparatus is described, with related systems and methods, which allows for hands-free use of a tablet device in conjunction with the use and control of a camera. The mounting apparatus can be used to support a tablet device in adjustable user-preferred configurations, for various modes of camera operation (e.g. standard photography mode, video mode, self-recording/capture mode). The adjustable configurations of the mounting apparatus can be used to align the tablet device over the center of gravity of the camera, allowing for a properly weight balanced configuration in the user's hand. The adjustable configurations of the mounting apparatus can be used to fold the mount into a compact position. It is further contemplated that additional accessory devices can be supported by the mounting apparatus. A wired or wireless connection between the tablet device and the camera allows for remotely viewing and operating the camera through the tablet device. The apparatus mounted tablet device can be used to augment the functionality and features of the camera.

### PRIORITY CLAIM

The present application claims the priority of U.S. Provisional Application No. 61/807917 filed on Apr. 3, 2013 and U.S. Provisional Application No. 61/847248 filed on Jul. 17, 2013, wherein all of the U.S. priority applications are herein incorporated by reference.

### TECHNICAL FIELD

This invention relates to apparatus, systems and methods for supporting a tablet device used with a camera.

### BACKGROUND

Tablet computers are portable one-piece computers with a touchscreen display screen. Tablet computers are typically used for viewing videos and documents, emailing, social networking, internet browsing, and the like.

A recent development in digital photography has been the use of tablet computers to control digital cameras, in particular to control digital single lens reflexive (DSLR) cameras. This approach allows the camera's field of view to be viewed in real time on the typically larger and higher resolution screen of the tablet computer. Users can also use the tablet device to remotely control the camera's functions and to view, edit, and otherwise manage images in the field without having to first return to a workstation or home computer. DSLR Controller™ is an example of enabling software.

It is usually not practical for a user to simultaneously hold a camera and operate a tablet computer to capture an image unless at least one of the two devices is independently supported, for example by a tripod in the case of the camera. Even if a hands-free support for the camera is available, it would be convenient for the user to be able to free up the hand(s) that would otherwise be needed to hold the tablet computer. Apparatus, systems and methods for addressing one or more of these needs would be desirable.

### SUMMARY OF THE INVENTION

In the present invention apparatus, systems and methods are provided which allow for hands-free use of a tablet device in conjunction with the use and control of a camera. Systems may comprise a tablet device (coupled to a tablet holder) attached to a camera by the use of an apparatus mount which is detachably coupled to both the tablet device holder and the camera. Methods may comprise the steps of attaching the apparatus mount base to the camera and the apparatus mount head to the tablet device (or tablet device holder), and adjusting the configuration of the mount to align the center of gravity of the tablet device over the center of gravity of the camera, resulting in a properly balanced configuration in the user's hand.

In preferred embodiments the apparatus may comprise a base, a lower arm, an upper arm and a head. The base is detachably coupleable to the tablet device (or holder of the tablet device). The apparatus may include at least two swinging pivot joints pivotable in the forward/rearward plane. In this preferred embodiment the swinging pivot joints may constrain and restrict movement along a plane orthogonal to a major plane of the tablet device.

In further aspects of preferred embodiments the apparatus may have a lower arm length to upper arm length ratio of approximately 1:3, enabling adjustable tablet device positioning (of possible varying tablet device sizes) for user-preferred configurations. In another aspect of preferred embodiments the upper arm may comprise of two segments with a level joint for levelling the tablet device in the horizontal axis, perpendicular to the axis of the pivot joints.

It is further contemplated that a preferred embodiment may be configured to allow the apparatus to be “folded-up” into a compact user-preferred position, while the apparatus remains attached to the camera. In yet further preferred embodiments the apparatus base may be comprised of two segments which are detachably coupled allowing for “quick release” aspects. It is further contemplated that the two segments may be rotatably coupled.

In preferred embodiments the apparatus may include pivot joints that comprise a rotatable tightening member for locking and unlocking the position of the apparatus, allowing for fixing and adjusting the configuration of the apparatus. In this preferred embodiment the unlocked configuration may include a “moveable-stiff” aspect, allowing fixed yet adjustable configuration without adjustment of a rotatable tightening member.

Still more preferred embodiments may additionally include an accessory device attached to an arm of the apparatus, which may include a camera flash, a microphone, a stabilizing handle, a hot shoe replacement or a holder for a backup battery.

The apparatus may be configured to adjust interchangeably between the various user-preferred configurations allowing for various modes of camera operations. These modes may include a video mode, a self-recording/capture mode and a standard operation mode. These user-preferred configurations may include a lowered position (with the tablet device screen aligned with a viewfinder position of the camera), a front-facing tablet device position, and a standard position with the tablet device vertically aligned above the center of gravity of the camera. It is further contemplated that the tablet device may be rotatable between a landscape orientation and a portrait orientation.

Various apparatuses, features, aspects, and advantages of the present invention will become more apparent from the following detailed description of preferred embodiments of the invention, along with the accompanying drawings in which numerals represent like components.

### BRIEF DESCRIPTION OF DRAWINGS

In drawings which show non-limiting embodiments of the invention:

FIG. 1 is a perspective view of an apparatus according to an embodiment of the invention mounting a tablet device on a DSLR camera;

FIG. 2 is a side view of the apparatus shown in FIG. 1;

FIG. 3 is a back view of the apparatus shown in FIG. 1;

FIG. 4 is a front view of the apparatus shown in FIG. 1;

FIG. 5A is a side view of a DSLR camera;

FIG. 5B is a side view of a non-articulated mount mounting a tablet device on a DSLR camera;

FIG. 5C is a side view of the apparatus shown in FIG. 1 mounting a tablet device on a DSLR camera;

FIG. 6 is a perspective view of an apparatus according to another embodiment of the invention mounting a tablet device on a DSLR camera;

FIG. 7 is a perspective view of an apparatus according to another embodiment of the invention mounting a tablet device on a DSLR camera;

FIG. 8A is a component of a tablet holder according to an embodiment of the invention; FIG. 8B is the component shown in FIG. 8A attached to a tablet cover; FIG. 8C is the component shown in FIG. 8A attached to a universal tablet holder;

FIG. 9 is a side view of an apparatus for mounting a tablet device on a DSLR camera according to an embodiment of the invention;

FIG. 10 a rear perspective view of an apparatus for mounting a tablet device on a DSLR camera in a compact folded position according to an embodiment of the invention; and

FIGS. 11A to 11D are side views of an apparatus for mounting a tablet device on a DSLR camera according to an embodiment of the invention in different configurations.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The invention relates to apparatus, systems and methods for supporting a tablet device being used with a camera. One aspect relates to an apparatus comprising a base, lower arm, upper arm, and head. The base is detachably coupleable to the camera, and the head is detachably coupleable to the tablet device (or a holder of the tablet device). The apparatus includes at least two swinging pivot joints pivotable in the forward/rearward plane to allow controlled and balanced mounting of the tablet device on the camera. Other aspects relate to related systems and methods.

A number of directional conventions are used in this specification to facilitate description of the invention, as follows: “forward”, “forwardly”, “front” and similar words refer to a direction toward the front (lens-side) of the camera when the apparatus is installed; “rearward”, “rearwardly”, “back”, “behind” and similar words refer to a direction toward the back (display screen side) of the camera when the apparatus is mounted on the camera.

The term “tablet device” as used in this specification refers to tablet computers, phablets, smartphones, and other standalone portable electronic devices with touchscreen/button control display screens. The term “tablet device” does not refer to computer monitors, field monitors, or television monitors. The term “camera” as used in this specification refers to digital single lens reflexive (DSLR) cameras, mirrorless interchangeable lens cameras (MILCs), and other similar devices with optical systems for detecting and recording digital still images and video.

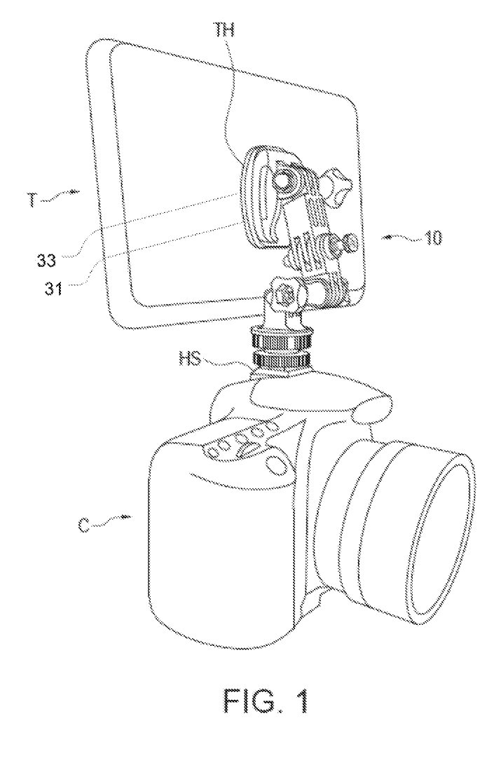

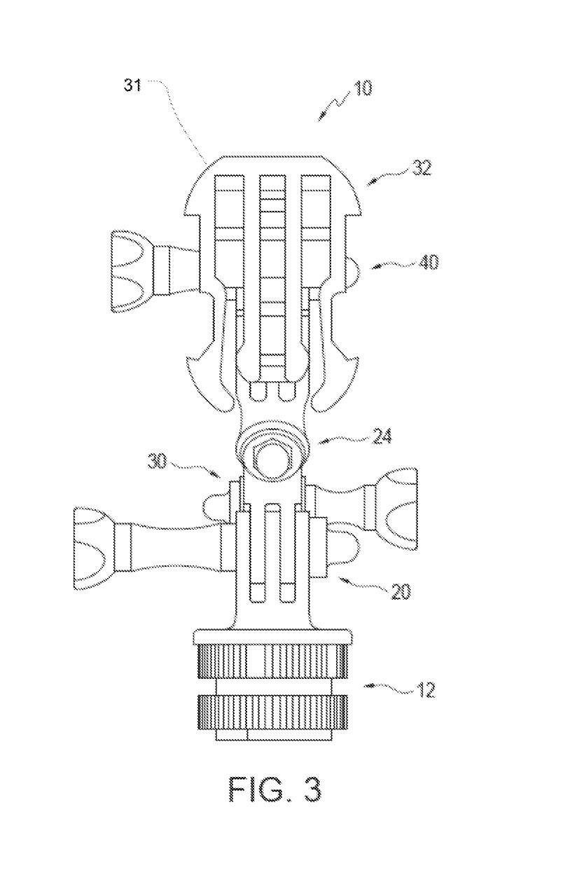

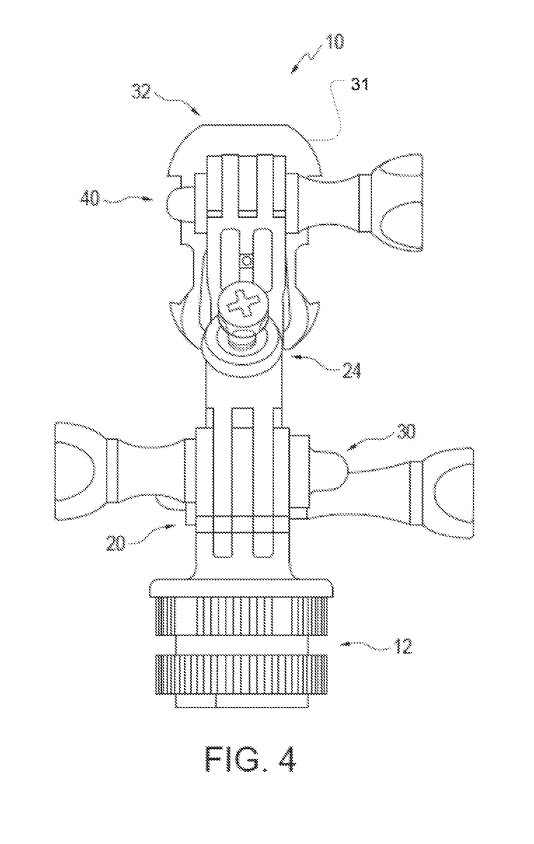

FIGS. 1 to 4 and 5c show an mount 10 according to one embodiment of the invention. Mount 10 is mounted on camera C at hot shoe HS. Tablet device T is attached to mount 10 by tablet holder TH.

Mount 10 includes a base 12. Base 12 includes a mount segment 14 and a base segment 16. The bottom of mount segment 14 is detachably coupleable to hot shoe HS of camera C. Mount segment 14 may include a means for locking base 12 to hot shoe HS. Mount segment 14 and base segment 16 are rotatably coupled. In some embodiments, mount segment 14 and base segment 16 may be integral and not rotatable with respect to each other. In some embodiments, base 12 may include a quick release coupling point (e.g. between mount segment 14 and base segment 16) to facilitate quicker removal of mount 10 from camera C compared to separation of mount 10 from camera C at the attachment point between the bottom of mount segment 14 and hot shoe HS. In some embodiments, base 12 may comprise a mating element (not shown) that mates with a corresponding mating element on or adjacent hot shoe HS that restricts coupling between mounts and cameras to only those with corresponding mating elements.

Mount 10 also includes a lower arm 18 coupled to base 12. Base 12 is pivotally coupled to lower arm 18 at lower pivot joint 20. Lower pivot joint 20 allows base 12 and lower arm 18 to pivot with respect to each other in the forward/backward plane. Lower arm 18 is at least upward forwardly orientable with respect to the position of base 12. In some embodiments, lower arm 18 is upward forwardly and upward backwardly orientable with respect to the position of base 12. In some embodiments, lower pivot joint 20 may be absent and instead base 12 fixedly coupled to, or integral with, lower arm 18; in such embodiments, lower arm 18 is fixed in an upward forwardly oriented direction.

Mount 10 also includes an upper arm 22 coupled to lower arm 18. Upper arm 22 is pivotally coupled to lower arm 18 at middle pivot joint 30. Middle pivot joint 30 allows upper arm 22 and lower arm 18 to pivot with respect to each other in the forward/backward plane. Upper arm 22 is at least upward rearwardly orientable with respect to the position of middle pivot joint 30. In some embodiments, upper arm 22 is upward rearwardly and upward forwardly orientable with respect to the position of middle pivot joint 30.

Upper arm 22 includes a lower segment 26 and an upper segment 28 pivotally coupled at a level joint 24. Level joint 24 allows lower segment 26 and upper segment 28 to pivot with respect to each other in a lateral plane. In some embodiments, level joint 24 may be absent, and lower segment 26 and an upper segment 28 may instead be a single integral element.

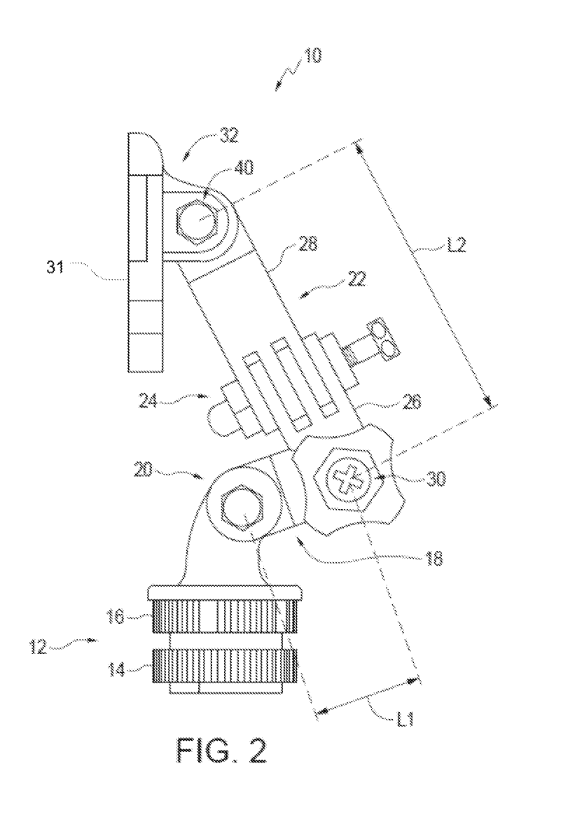

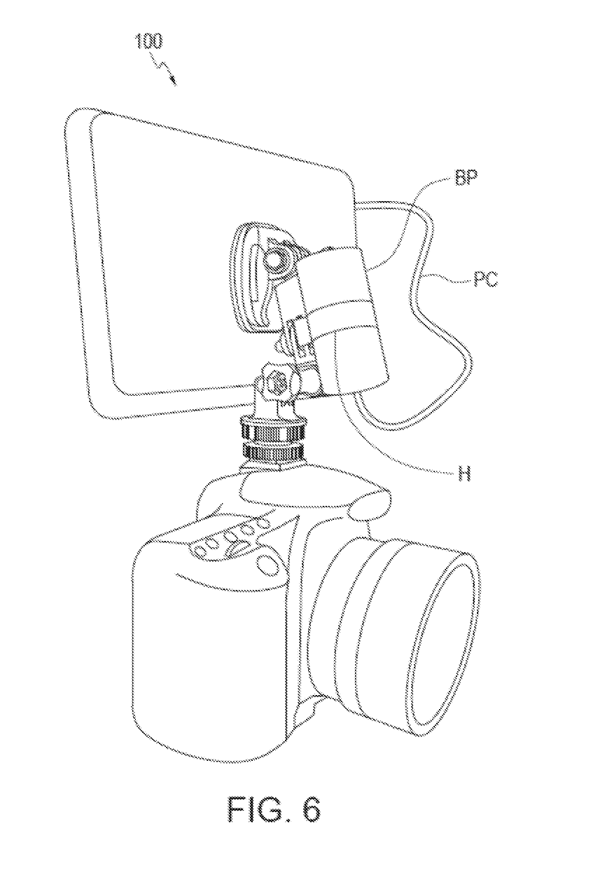

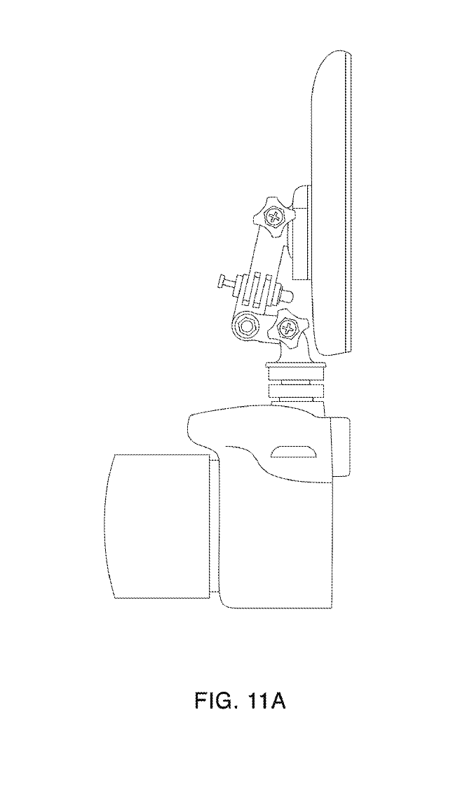

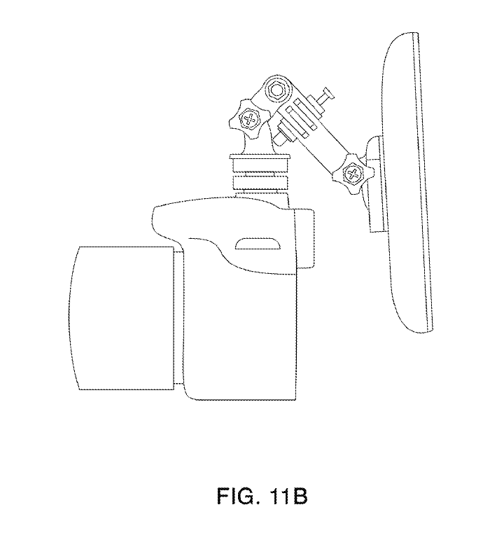

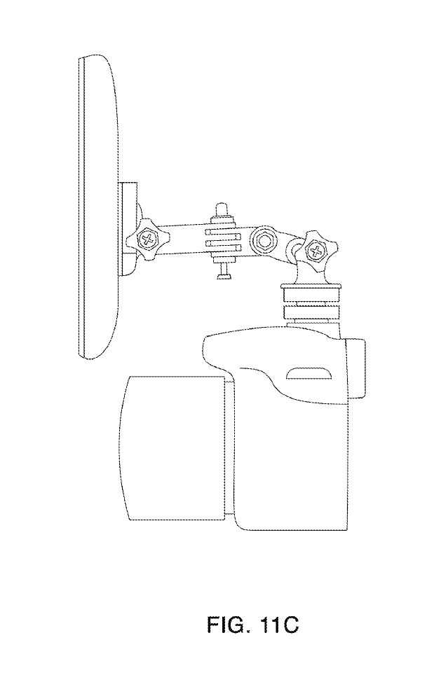

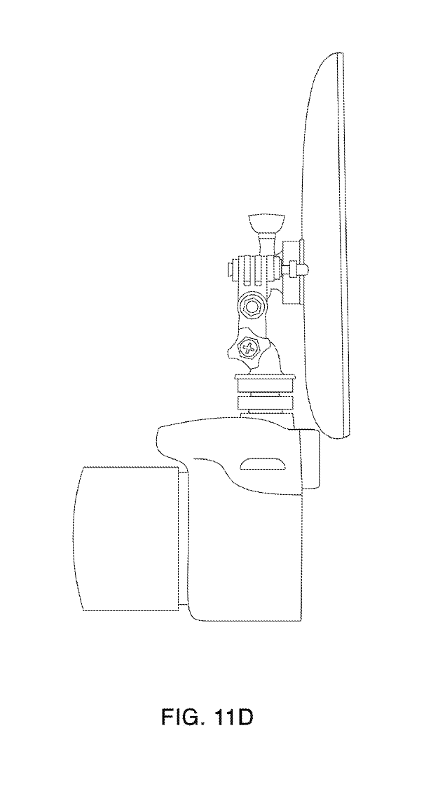

As shown in FIG. 2, length L1 of lower arm 18 is defined as the distance from the axis of lower pivot joint 20 to the axis of middle pivot joint 30, and length L2 of upper arm 22 is defined as the distance from the axis of middle pivot joint 30 to the axis of upper pivot joint 40. The ratio of L1 to L2 in the embodiment shown is approximately 1:3. In some embodiments the ratio of L1 to L2 may range from 1:2 to 1:4. Upper arm 22 being longer than lower arm 18 by these ratios has a number of advantages. For example, providing a relatively shorter lower arm 18, which is oriented in the forward direction, provides greater stability and minimizes the downward stress placed on middle pivot joint 30 (and to a lesser extent lower pivot joint 20). The relatively longer upper arm 22 allows for larger tablet devices to be accommodated with sufficient clearance in “landscape” and “portrait” position center of gravity-balanced configurations (see FIGS. 11A and 11D, respectively), allows for the tablet device to be lowered closer to the camera in certain configurations (see FIG. 11B), and in some embodiments allows room for an attachment on upper arm 22 such as a backup battery pack BP and other accessories for tablet device T by way of a holder (see FIG. 6).

Mount 10 also includes a head 32 coupled to upper arm 28. One side of head 32 is pivotally coupled to upper arm 28 at upper pivot joint 40. The other side of head 32 comprises a tablet holder TH which supports tablet device T.

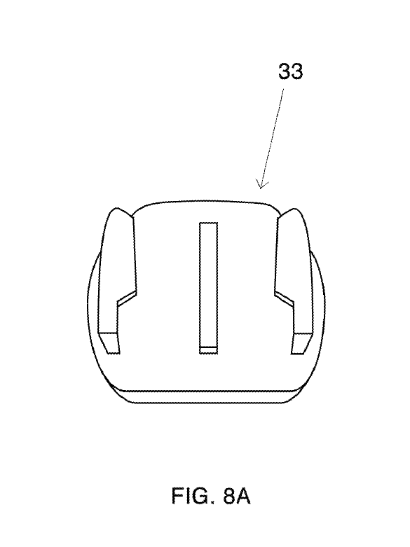

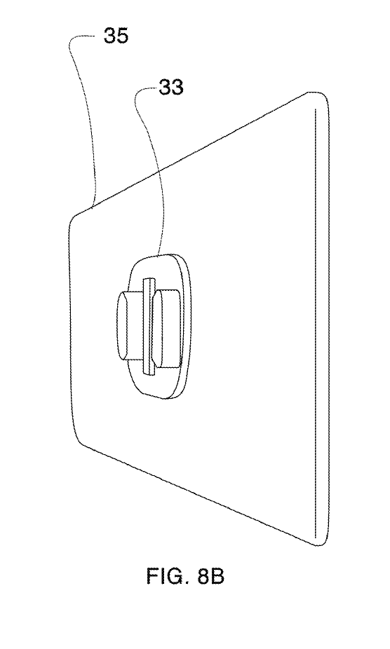

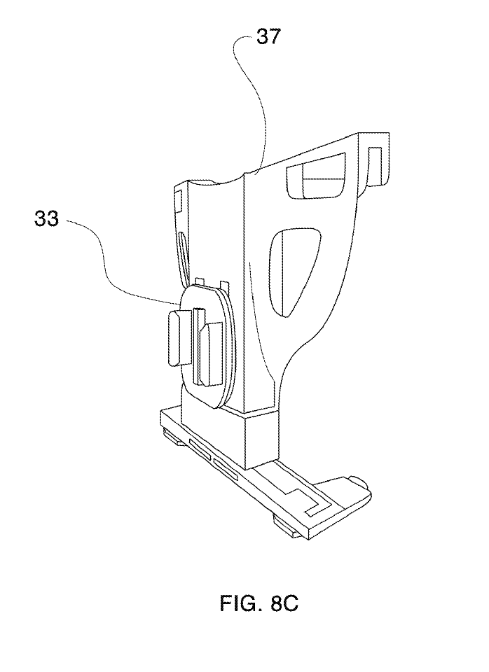

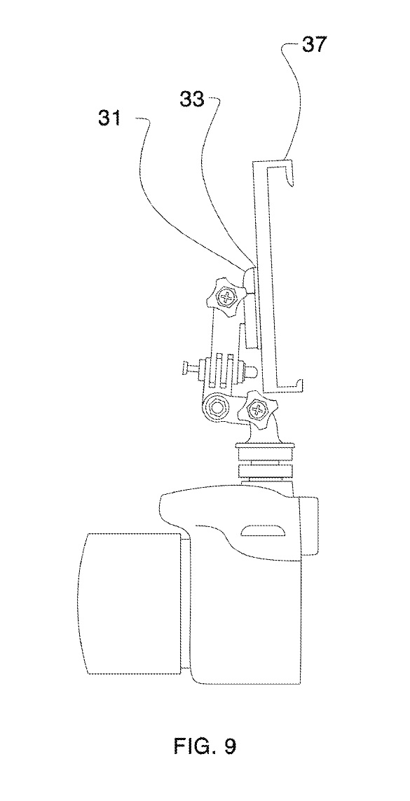

In some embodiments, tablet holder TH comprises a first element 31 fixed to head 32 and a second element 33 detachably coupleable with the first element. First element 31 and second element 33 may couple by suitable detachable means such as hinged clip mechanisms (as illustrated in the Figures), friction fit mechanisms, hook and loop fasteners, magnets, straps, and the like. Second element 33 may for example be fixed directly to, or integral with, the back of a tablet device T, to the back of a dedicated case 35 for tablet device T (as shown in FIG. 8B), and/or to a universal tablet device holder 37 such as a universal frame-type holder (as illustrated in FIG. 8C and FIG. 9). Universal tablet device holder 37 has adjustable arms that accommodate holding different sizes of tablet devices T regardless of whether or not tablet device T is used with a case, and if used with a case regardless of the type of case. Tablet holder TH thus enables a user to quickly and easily remove tablet device T (as well as universal tablet device holder 37) from mount 10 and switch tablet devices T for mount 10. In some embodiments, universal frame-type holder 37 may be provided in at least two sizes: one larger size to accommodate different sizes of tablet computers and one smaller size to accommodate different sizes of smartphones. In some embodiments, tablet holder TH may comprise a universal frame-type holder 37 directly fixed to, or integral with, head 32, without first and second elements 31 and 32 provided therebetween. In some embodiments, tablet holder TH as described herein may be provided at the head of any type of mount that couples a tablet device T to a hot shoe HS of a camera C by way of detachable coupling to a base of the mount.

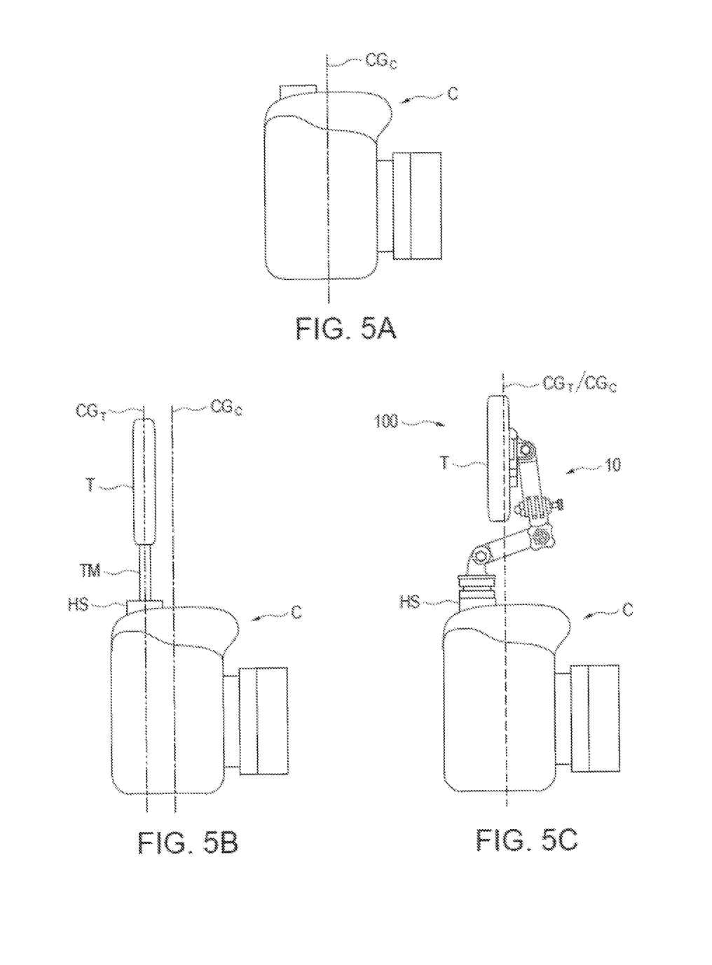

As best shown in FIG. 2, the axes of lower pivot joint 20, middle pivot joint 30 and upper pivot joint 40 are parallel and permit pivoting of mount 10 in the forward/rearward plane to allow a user to balance the weight of tablet device T, tablet holder TH, and mount 10 over the center of gravity of camera C, as further described below in relation to FIGS. 5A to 5C (and shown in FIGS. 11A and 11D). Middle pivot joint 30 is configurable forward of lower pivot joint 20. Upper pivot joint 40 is configurable rearward of middle pivot joint 30. In some embodiments, such as that illustrated in FIG. 2, all of the pivot joints of mount 10 are swinging pivot joints, that is, joints constrained for movement along a single plane to facilitate smooth and controlled transition between configurations of mount 10 (as shown for example in FIGS. 11A to 11D). In such embodiments, lower pivot joint 20, middle pivot joint 30 and upper pivot joint 40 constrain movement of arms 18, 22 and head 32 along a plane orthogonal to the major plane of tablet device T when mount 10 is coupled to tablet device T. In some embodiments, level joint 24 may be absent, and thus all of the pivot joints of mount 10 are swinging pivot joints which constrain movement of arms 18, 22 and head 32 along a plane orthogonal to the major plane of tablet device T when mount 10 is coupled to tablet device T.

Each of lower pivot joint 20, middle pivot joint 30, upper pivot joint 40 and level joint 24 are friction-based clamp/tightening mechanisms. Each joint also has a rotatable tightening knob for configuring the pivot joints between a locked position (i.e., tightly clamped) for fixing the configuration of mount 10 and one or more unlocked positions for adjusting the configuration of mount 10. In some embodiments, the unlocked position may include a “movable-stiff” configuration that simultaneously provides sturdy and stiff, yet adjustable, positioning, obviating the need to loosen or tighten the clamping/tightening mechanism at each pivot joint when adjusting the configuration of mount 10. The swinging pivot joints of mount 10 ensures the alignment of mount 10 is maintained along a common plane even when the clamping mechanisms are loosened beyond a “movable-stiff” position for adjustment between configurations. In some embodiments, one or more of the rotatable tightening knobs may be absent. In some embodiments, means other than a friction-based clamp/tightening mechanism may be used to control the pivoting action of one or more of lower pivot joint 20, middle pivot joint 30, upper pivot joint 40 and level joint 24. For example, pivoting means may comprise a racheting pawl/notch mechanism or other suitable controllably pivotable mechanism known to persons skilled in the art.

FIG. 5A shows a conventional DSLR camera C. A lateral plane CG_{C} passes through the center of gravity of camera C. The weight of camera C is equally distributed between the part of camera C in front of plane CG_{C} and the part of camera C behind plane CG_{C}, facilitating level positioning and even weight distribution of camera C in a user's hands.

FIG. 5B shows camera C, and a tablet device T mounted on camera C by a non-articulated tablet mount TM. In addition to lateral plane CG_{C} passing through the center of gravity of camera C, FIG. 5B also shows a lateral plane CG_{T} passing through the combined center of gravity of the tablet device T and tablet mount TM. As shown, plane CG_{T} is rearwardly offset from plane CG_{C}, resulting in the overall center of gravity of the system shifting rearward of plane CG_{C}. Shifting the overall center of gravity away from CG_{C} can throw off the balance of camera C in a user's hands.

FIG. 5C also shows a system 100 including a camera C, and a tablet device T mounted on camera C by mount 10. Unlike FIG. 5B, the adjustable nature of mount 10, as described above, allows lateral plane CG_{T} passing through the center of gravity of the tablet device T and mount 10 to be aligned with lateral plane CG_{C} passing through the center of gravity of camera C. The overall center of gravity of system 100 is therefore maintained in the forward/rearward direction, maintaining the balance of camera C in a user's hands.

Adjustability of mount 10 allows alignment of planes CG_{T} and CG_{C} when plane CG_{T} is altered, for example if a tablet device of a different size, shape and/or weight is used. Adjustability of mount 10 also allows alignment of planes CG_{T} and CG_{C} when plane CG_{C} is altered, for example if the optical zoom on camera C is adjusted or if the lens on camera C is exchanged with a lens of a different size, shape and/or weight.

In operation, a user attaches base segment 14 of base 12 to hot shoe HS of camera C. Base 12 may be locked in position. The user attaches tablet device T to a tablet holder TH, and attaches head 32 to tablet holder TH. Alternatively, tablet device T and tablet holder TH may be attached to head 32 of mount 10 first, and then base segment 14 of base 12 attached and optionally locked to hot shoe HS of camera C. Next, as shown in FIG. 5C, mount 10 is adjusted so that the combined center of gravity of tablet device T, tablet holder TH, and mount 10 is centered over the center of gravity of camera C. Adjustment may require pivoting lower arm 18 at lower pivot joint 20 and/or pivoting upper arm 22 at middle pivot joint 30. In addition to the positioning of tablet device T in a “landscape” position in the center of gravity-balanced position of FIG. 5C (and FIG. 11A), mount 10 may also be configured in other configurations such as illustrated in FIGS. 11B to 11D: FIG. 11B shows tablet device T in a lowered, compact configuration which may be useful for video mode operation of camera C; FIG. 11C shows tablet device T facing the front of camera C, and FIG. 11 D shows tablet device T in a “portrait” position in a raised, center of gravity-balanced configuration.

Tablet device T may be rotated about the axis of base 12 by rotating mount segment 16 relative to base segment 14. Tablet device T may be tilted to a user's desired position (usually with the major surface of tablet device T at a vertical) by pivoting mount 10 at upper pivot joint 40. Once tablet device T is tilted to the user's desired position, the user may also make fine adjustments at middle pivot joint 30 and/or lower pivot joint 20 to compensate for any changes to the center of gravity of the combination of tablet device T and camera C caused by pivoting at upper pivot joint 40. Tablet device T may be leveled laterally as necessary by pivoting upper segment 28 of upper arm 22 at level joint 24.

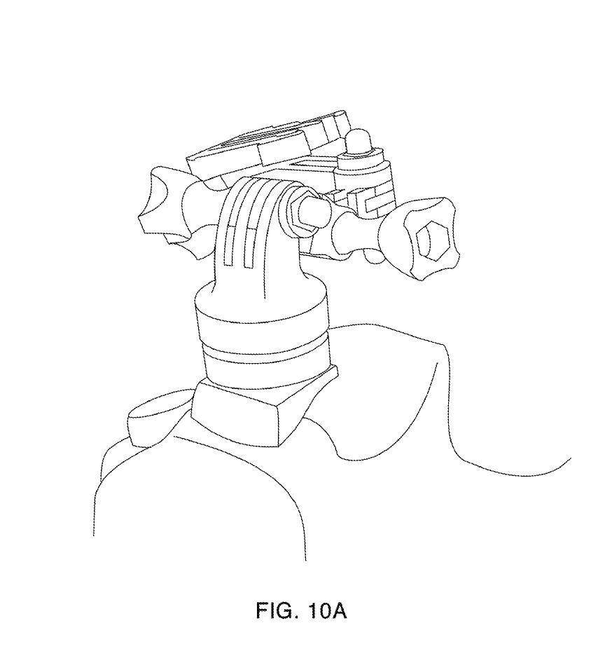

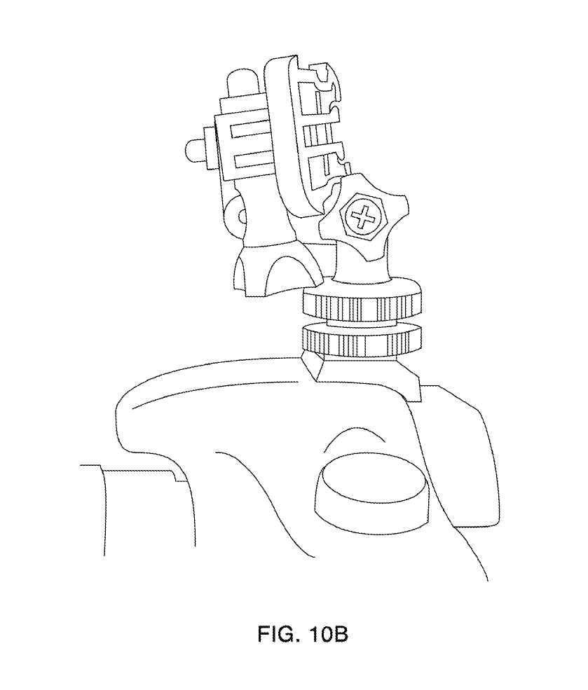

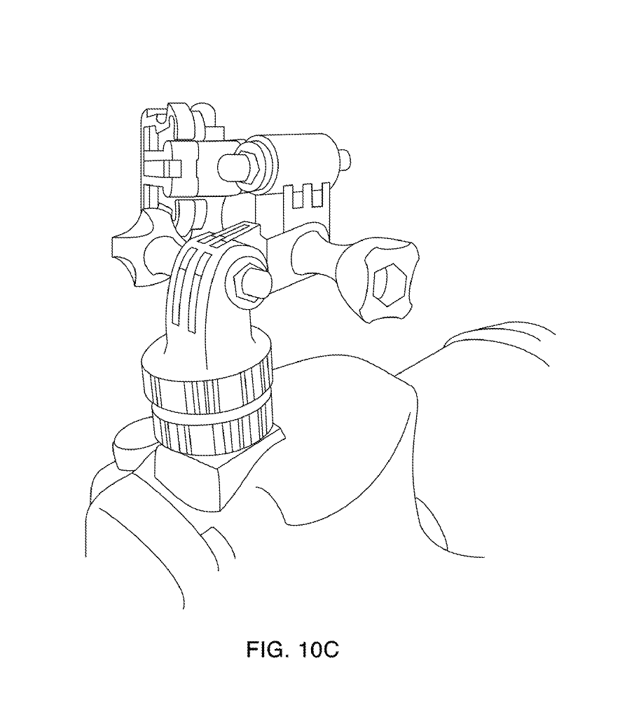

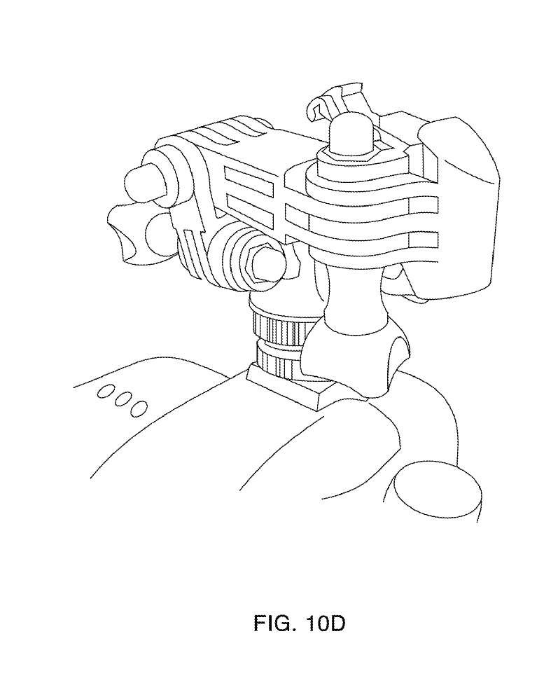

When not in use, a user may remove mount 10 from hot shoe HS. In the alternative, if the user wishes to keep mount 10 on camera C, the user can detach second element 33 from first element 31 and fold mount 10 into a compact configuration as shown for example in FIG. 10.

Where a component (e.g. pivot joint, arm, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

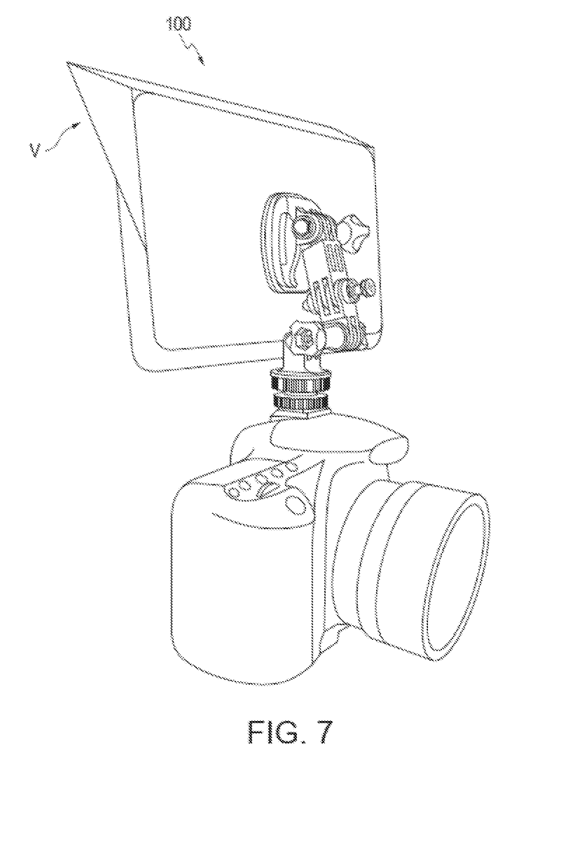

As will be apparent to those skilled in the art in the light of the foregoing disclosure, many alterations and modifications are possible in the practice of this invention without departing from the spirit or scope thereof. For example:
lower arm 18 and/or upper arm 22 may be telescoping to provide additional adjustment of mount 10.
instead of a lower arm 18 and upper arm 22, mount 10 may only have one arm that is pivotally connected, by way of swinging pivot joints, to base 12 at one end and head 32 at the other end. The swinging pivot joints may have parallel axes to constrain movement of the single arm and head 32 in a plane orthogonal to the major plane of tablet device T when tablet device T is coupled to mount 10.
instead of a lower arm 18 and upper arm 22, mount 10 may have more than two arms, serially connected by way of swinging pivot joints. The swinging pivot joints may have parallel axes to constrain movement of all of the arms and head 32 in a plane orthogonal to the major plane of tablet device T when tablet device T is coupled to mount 10.
any one of head 32, upper arm 28, lower arm 18, and base 12 may support one or more of the following accessories:
a holder H for holding a battery pack of tablet device T. For example, as shown in FIG. 6, holder H may be disposed on upper arm 28 at level joint 24 for holding a back up battery pack BP for tablet device T by way of known detachable fastening means such as clips, hook and loop fasteners, and the like. Battery pack BP and Tablet device T may be connected by a power cord PC;
a handle for providing additional stability, for example for shooting video. The handle may be configured to extend sideways (right or left) and/or forwardly;
a flash for camera C, for example triggered wirelessly instead of through hot shoe HS;
a microphone, for example for shooting video; and
a hot shoe or cold shoe mount connector to substitute for the hot shoe used by mount 10.
system 100 may include a visor assembly V for the tablet device T, such as shown in FIG. 7. The visor assembly may comprise one or more panel shaped visors detachably coupled to one or more outer edges of tablet device T.

What is claimed:

1. An apparatus for hands-free use of a tablet device in conjunction with use of a camera, the apparatus comprising:
a base detachably coupleable to a hot shoe of the camera;
a forwardly orientable lower arm comprising a first end and a second end, the first end coupled to the base;
a rearwardly orientable upper arm comprising a first end and a second end, the first end pivotally coupled at a middle pivot joint to the second end of the lower arm;
a head detachably coupleable to a holder for a tablet device, the head pivotally coupled at an upper pivot joint to the second end of the upper arm.

2. The apparatus of claim 1, wherein the first end of the lower arm is pivotally coupled at a lower pivot joint to the base.

3. The apparatus of claim 2, wherein axes of the lower pivot joint, the middle pivot joint and the upper pivot joint are parallel.

4. The apparatus of claim 3, wherein the axes of the pivot joints are parallel to a plane of a major surface of the tablet device.

5. The apparatus of claim 4, wherein the middle pivot joint is configurable forward of the lower pivot joint, and wherein the upper pivot joint is configurable rearward of the middle pivot joint.

6. The apparatus of claim 5 wherein a distance from the lower pivot joint to the middle pivot joint defines a first length, and a distance from the middle pivot joint to the upper pivot joint defines a second length, wherein a ratio of the first length to the second length is between 1:2 and 1:4, inclusive.

7. The apparatus of claim 6 wherein the ratio of first length to the second length approximately 1:3.

8. The apparatus of claim 7 wherein the upper arm comprises a lower segment and an upper segment pivotally coupled at a level joint for levelling the tablet device along the plane of the major surface, wherein the axis of the level joint is perpendicular to the axes of the pivot joints.

9. The apparatus of claim 8, wherein the apparatus is configured in a compact folded position.

10. The apparatus of claim 7 wherein the base comprises:
a mount segment detachably coupleable to the hot shoe; and
a base segment pivotally coupled to the lower arm,
wherein the mount segment and the base segment are detachably coupled.

11. The apparatus of claim 10 wherein the base comprises:
a mount segment detachably coupleable to the hot shoe; and
a base segment pivotally coupled to the lower arm,
wherein the mount segment and the base segment are rotatably coupled.

12. The apparatus of claim 7 wherein each of the pivot joints comprises a rotatable tightening member for configuring the pivot joints in a locked configuration for fixing the configuration of the apparatus and an unlocked configuration for adjusting the configuration of the apparatus.

13. The apparatus of claim 12, wherein the unlocked configuration includes a “movable-stiff” unlocked position.

14. The apparatus of claim 7, wherein the pivot joints are swinging pivot joints constrained in movement along a plane orthogonal to the major plane of the tablet device.

15. The apparatus of claim 7 further comprising a holder disposed on the upper arm for holding a back up battery pack for the tablet device.

16. The apparatus of claim 7 further comprising an accessory device supported on at least one of the lower arm, the upper arm, the base and the head.

17. The apparatus of claim 16, wherein the accessory device is selected from the group consisting of:
(a) a camera flash;
(b) a microphone;
(c) a handle; and
(d) a hot shoe replacement.

18. The apparatus of claim 7, wherein the apparatus is configured to adjust interchangeably between the configurations of:
(a) a lowered position with the tablet device closer the camera;
(b) a front facing tablet device position;
(c) a standard position wherein the tablet is position above the camera vertically aligned with a center of gravity of the camera.

19. The apparatus of claim 7, wherein the apparatus is configured with the tablet device in a portrait orientation.

20. The apparatus of claim 19, wherein the tablet device is rotatable interchangeably between the portrait orientation and a landscape orientation.

21. A system comprising:
a tablet device;
a tablet device holder coupled to the tablet device;
a DSLR camera comprising a hot shoe;
an apparatus according to any one of claims 1 to 20 wherein the head is detachably coupled to the tablet device holder and the base is detachably coupled to the hot shoe.

22. A system according to claim 21 further comprising a visor for the tablet device, wherein a visor assembly is detachably coupled to at least one outer edge of the tablet device.

23. A system according to claim 21, wherein the head is detachably coupled to a tablet device holder, wherein the tablet device holder is interchangeable between at least two different sized tablet device holders.

24. A method of mounting a tablet device on a camera, the method comprising the steps of:
(a) providing an apparatus according to any one of claims 1 to 20;
(b) attaching the base of the apparatus to a hot shoe of the camera;
(c) attaching the head of the apparatus to the tablet device;
(d) adjusting the configuration of the mount apparatus to align a center of gravity of the mount apparatus and tablet device over a center of gravity of the camera.

25. A method according to claim 24, wherein step (c) comprises attaching a first side of a holder to the tablet device, and then attaching a second side of the holder to the head of the apparatus.

26. A method for controlling one or more functions of a camera through a tablet device comprising the steps of:
(a) mounting the tablet device on the camera according to the method of claim 24;
(b) establishing a wired or wireless connection between the tablet device and the camera;
(c) running software for remotely operating the camera through the tablet device;
(d) inputting camera function commands into the tablet device.

27. A method for controlling one or more functions of a camera through a tablet device comprising the steps of:
(a) mounting the tablet device on the camera according to the method of claim 25;
(b) establishing a wired or wireless connection between the tablet device and the camera;
(c) running software for remotely operating the camera through the tablet device;
(d) inputting camera function commands into the tablet device.
